(19) United States
(12) Patent Application Publication
(10) Pub. No.: US 2026/0021783 A1
(43) Pub. Date: Jan. 22, 2026

(54) VEHICLE SIDE UNDERRIDE GUARD AND RELATED DEVICES, SYSTEMS, AND METHODS

(71) Applicant: Holt Sales and Service, LLC, Des Moines, IA (US)

(72) Inventor: Jeremy Drever, Ankeny, IA (US)

(21) Appl. No.: 19/271,341

(22) Filed: Jul. 16, 2025

Related U.S. Application Data
(60) Provisional application No. 63/672,043, filed on Jul. 16, 2024.

(51) Int. Cl. B60R 19/56

(52) U.S. Cl. CPC B60R 19/565

(57) ABSTRACT

A side underride guard comprising a first front mount disposed on a first side of a semi-trailer and a second front mount disposed on a second side of the semi-trailer, a first rear mount disposed on the first side of a semi-trailer and a second rear mount disposed on the second side of the semi-trailer, a first cable spanning between the first front mount and the first rear mount along the first side of the semi-trailer and a second cable spanning between the second front mount and the second rear mount along the second side of the semi-trailer, and one or more braces affixed to the first rear mount and second rear mount.

### CROSS-REFERENCE TO RELATED APPLICATIONS

This application claims the benefit under 35 U.S.C. § 119 (e) to U.S. Provisional Application 63/672,043, filed Jul. 16, 2024, and entitled “VEHICLE SIDE UNDERRIDE GUARD AND RELATED DEVICES, SYSTEMS, AND METHODS,” which is hereby incorporated by reference in its entirety for all purposes.

### TECHNICAL FIELD

The disclosure relates to technologies useful for improving vehicle safety and aerodynamics. Specifically, this disclosure relates to improving semi-truck and trailer and vehicle safety and aerodynamics.

### BACKGROUND

Large vehicles like combination vehicles, often referred to as semi-trucks or semi-tractor-trailers, pose additional risks to roadway safety due to their large size and certain design features. One hazard is the possibility that another vehicle may go underneath a semi-truck or trailer, between the axles, due to their high ground clearance. Additionally, objects may enter underneath a semi-trailer and interfere with the rear wheels of the trailer, potentially causing loss of control of the semi-truck. There is a need in the art to mitigate these risks.

Further, it is generally understood these large vehicles are not aerodynamic, causing increased fuel consumption and drag. There is a need for improved tools for improving the aerodynamics of these large vehicles for increasing fuel efficiency and reducing drag.

### BRIEF SUMMARY

Described herein are various implementations relating to systems and devices for improving safety of vehicles, including tractor-trailers, semi-truck, and the like. The described systems and devices provide protection from vehicles, such as smaller passenger vehicles entering the space between semi-truck axles and trailer axles. The disclosed system and devices may also improve the aerodynamics of the vehicle and/or trailer by reducing the aerodynamic drag of the vehicle and/or trailer. In various implementations, the system and devices employ a series of tensioned cables that can repel vehicles from entering the space between the axles and optionally support panels for improvements to aerodynamics and fuel usage.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A shows the side underride guard on a trailer, according to one implementation.

FIG. 1B shows the side underride guard on a trailer with shields, according to one implementation.

FIG. 2A is a perspective view of the side underride guard, according to one implementation.

FIG. 2B is a perspective view of the side underride guard with shields, according to one implementation.

FIG. 3 is a side view of the landing gear and front mount of the side underride guard, according to one implementation.

FIG. 4 is a side view the front mount of the side underride guard, according to one implementation.

FIG. 5 is a perspective view of the landing gear and front mounts of the side underride guard, according to one implementation.

FIG. 6 is a perspective view of a rear mount of the side underride guard, according to one implementation.

FIG. 7 is a side, perspective view of the rear mount of the side underride guard, according to one implementation.

FIG. 8 is a perspective view of the rear mounts with braces of the side underride guard, according to one implementation.

FIG. 9 is a rear view of the rear mounts with braces of the side underride guard, according to one implementation.

FIG. 10 is a perspective view of the side underride guard, according to one implementation.

FIG. 11A is a top view of the side underride guard on a trailer, according to one implementation.

FIG. 11B is a side view of the side underride guard on a trailer, according to one implementation.

### DETAILED DESCRIPTION

Described herein are side underride guards and associated devices and systems for providing increased safety and aerodynamics of semi-truck and trailers. Various implementations of the side underride guards may be used in connection with semi-trailers and similar vehicle types, that typically have high decks.

As would be understood, semi-trailer decks are high because their decks need to be placed about the same height as shipping docks, which are generally about 42 inches to about 52 inches above the ground, to allow for loading and unloading of cargo. Flatbed trailers may also have high decks when configured to load and unload their cargo at shipping docks. Various alternative vehicle and/or trailer types may include high/raised decks and therefore may gain advantages from the disclosed side underride guard and related systems and devices.

The deck of a trailer being at a raised height results in a large void under the deck of the trailer between the axles of the semi-truck and the axles of the trailer. This large void poses a risk to vehicles sharing the road with the trailer due to the ability for vehicles to end up partially or entirely between the axles. As would be understood, the presence of a vehicle underneath a trailer like a semi-trailer is dangerous. Increased roadway safety is of high concern for those that share the road. By limiting the ability of smaller vehicles to enter the space beneath a trailer and between the axles, risk to those smaller vehicles is mitigated, as well as risk to the operators of the large vehicle/tractor-trailer. Mitigating risk and thereby increasing safety also has the add-on effect of improving efficiency, reducing downtime, and reducing costly repairs that may be necessitated by accidents.

As would also be understood, objects (including, but not limited to smaller vehicles and animals) and debris (including, but not limited to rocks and broken vehicle parts) can enter this void during travel. The objects and debris may then collide with the axles, wheels, and/or suspension components of the trailer and cause damage or dangerous situations. As would be known to those in the art, a sharp object may puncture a tire on the trailer, potentially leading to a tire blowout that risks loss of control of the trailer and cab, as well as the potential for tire debris to collide with other nearby vehicles. Likewise, a large object may roll under the wheels of the trailer, causing the trailer to lurch into the air as the wheels rolls over the object. The return of the trailer to the ground may also cause to tire blowouts or the loss of control of the cab and trailer. Of course many other situations may occur, such as objects wrapping themselves around the wheels or an object tipping a trailer to one side. The implementations described herein provide a side underride guard to prevent such incidents, along with related devices and systems.

As trailers are transported, the space between the axles becomes a low pressure zone. This is due to the cab displacing air during travel, which leaves less air immediately behind the cab—where the void under the trailer deck is located. Due to the low pressure, air from the surrounding environment rushes into the void, which then collides with the wheels and suspension components of the trailer. This inrush of air increases aerodynamic drag on the trailer. Additionally, the low pressure zone can draw in passing vehicles toward the space between the axles increasing the threat of a vehicle entering that space and causing a hazard.

Additionally, this air can carry roadside debris, which can become entangled in or cause damage to the wheels and suspension components, as discussed above. Additionally, the pull of the air can cause other vehicles on the road to drift into or towards the trailer.

The side underride guard and associated devices and systems disclosed herein optionally provide decreased aerodynamic drag and reduce debris incursion. Of course, the side underride guard may be applied in numerous similar implementations to provide the same solutions in addition to the implementation described in detail herein. For instance, the side underride guard and associated devices and systems may be implemented on vehicles with high ground clearance to yield the same advantages as would be seen on the trailer implementation, such as buses or agricultural equipment.

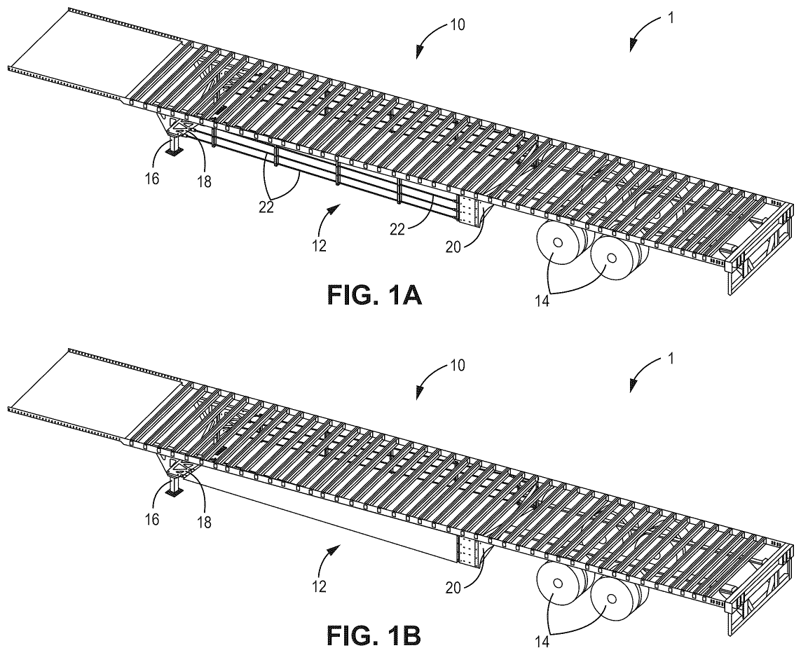

Turning to the figures in more detail, FIGS. 1A and 1B show the system 1, as applied to a trailer 10. The system 1, in some implementations, includes a side underride guard 12. The side underride guard 12 may optionally be mounted below the sides of the trailer 10, between the wheels/axles 14 and the landing gear 16. Alternatively, the side underride guard 12 may be mounted between the wheels/axles 14 of alternative vehicle types. Further, the side underride guard 12 may be located between the semi-truck axles and the trailer axles.

In various implementations, the side underride guard 12 may have front mount 18 and a rear mount 20, for attaching the side underride guard 12 to the trailer 10. Optionally, one or more cables 22 may be strung between the front mount 18 and rear mount 20, forming a wire structure/frame. In various implementations, use of cables 22 allows for flexible ground clearance, which can be useful for driving across railroad tracks or other similar uneven or rough roads/terrain. In some implementations, the cables 22 may be braided metal cables, although cables or wires of any suitable material may be used, as would be understood by those of skill in the art. In various implementations, the cables 22 are under constant tension.

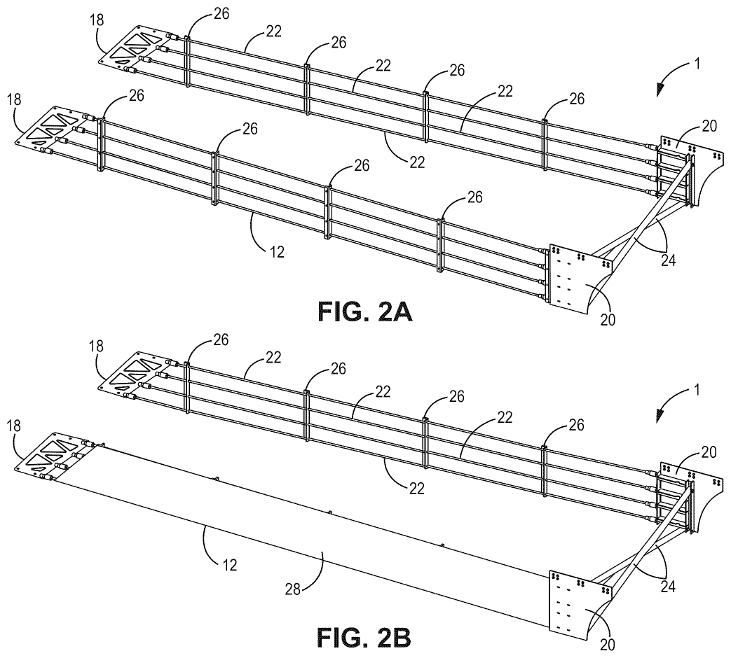

Turning to FIGS. 2A and 2B, in various implementations, between the rear mounts 20, there may be one or more braces 24. As would be understood, the braces 24 may reinforce the rear mounts 20 and the side underride guard 12 in resisting forces from vehicles, wind, and debris that may interact with the side underride guard 12. The braces 24, in various implementations, may be crossed relative to one another, substantially parallel, or in any other configuration known in the art.

In various implementations, the side underride guard 12 may have a one or more brackets/supports 26, disposed along the sides of the side underride guard 12. In various implementations, the brackets 26 may be mounted to the cables 22 and distributed along the length of the cables 22. That is in various implementations, the cables 22 are threaded through openings in the brackets 26, such that the brackets 26 support the cables along the length of the side underride guard 12.

Shown in FIGS. 1A and 2A, the side underride guard 12 may optionally have a wind shield/panel 28 attached to or otherwise engaged with the plurality of brackets 26, according to some implementations. The wind shields 28 may be flat, thin, lightweight panels, in some implementations. In various implementations the wind shields 28 may be made of a lightweight material, such as fiberglass, sheet metal, plastic, or a similar material known in the art. As would be understood, the panels 28 may provide aerodynamic advantages and improve fuel efficiency.

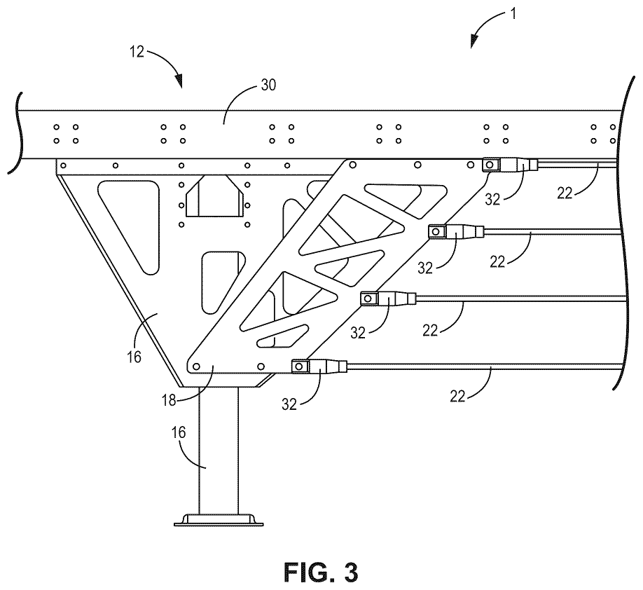

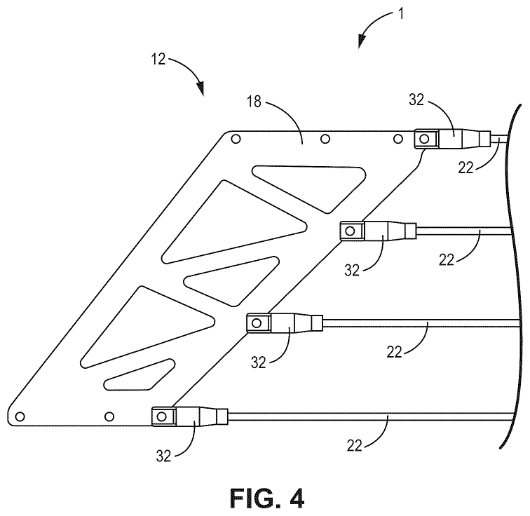

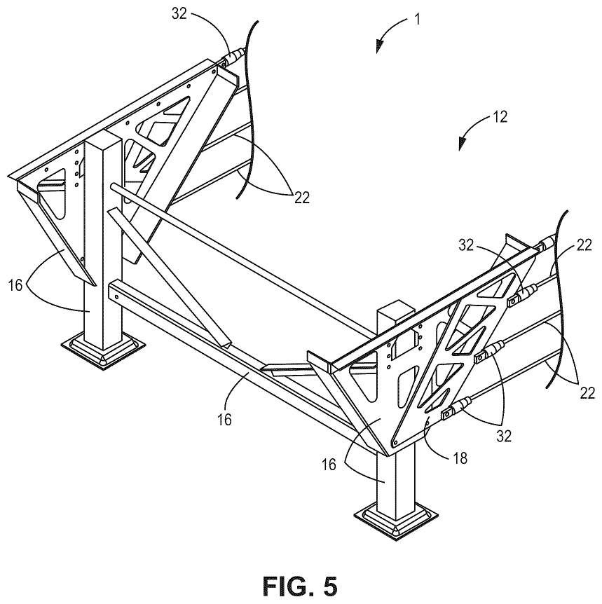

Turning now to FIGS. 3, 4, and 5, the front mount 18, in some implementations, may optionally be attached to the landing gear 16 or other appropriate location, as would be appreciated. In certain implementations, the front mount 18 may be attached to other components of the trailer 10, such as the deck structure 30. In various implementations, the front mount 18 may be attached to both the landing gear 16 and the deck structure 30. In various implementations, the cables 22 may be attached to the front mount 18 using termination devices 32. In various implementations, the termination devices 32 may be stud-end plug-lock wire rope end fittings, Clevis-end plug-lock wire rope end fittings, eye-end plug-lock wire rope end fittings, or similar fittings and attachment devices and mechanisms known in the art.

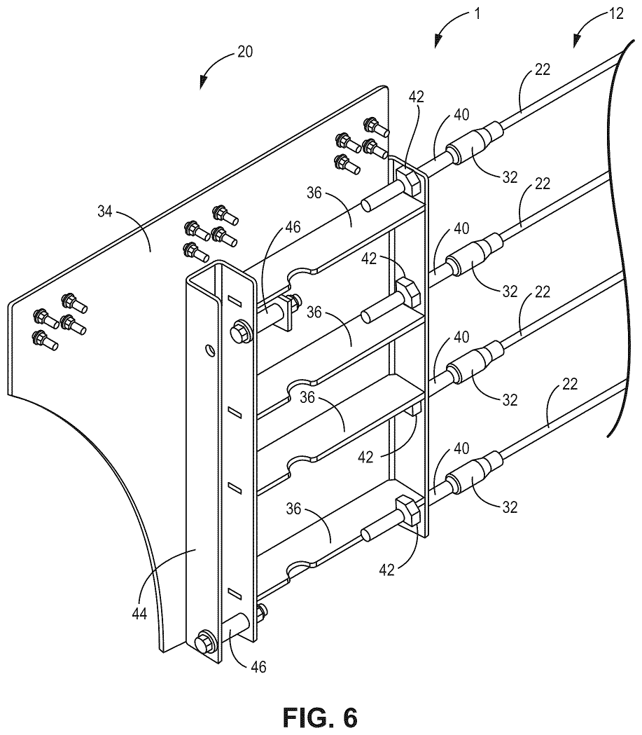

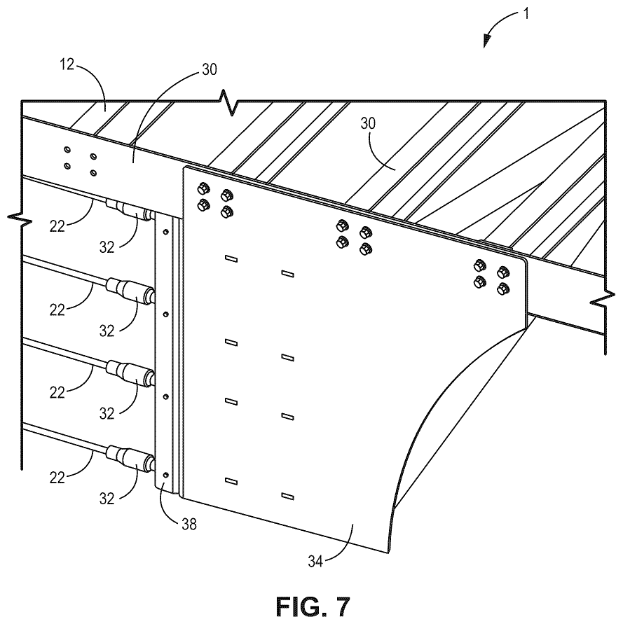

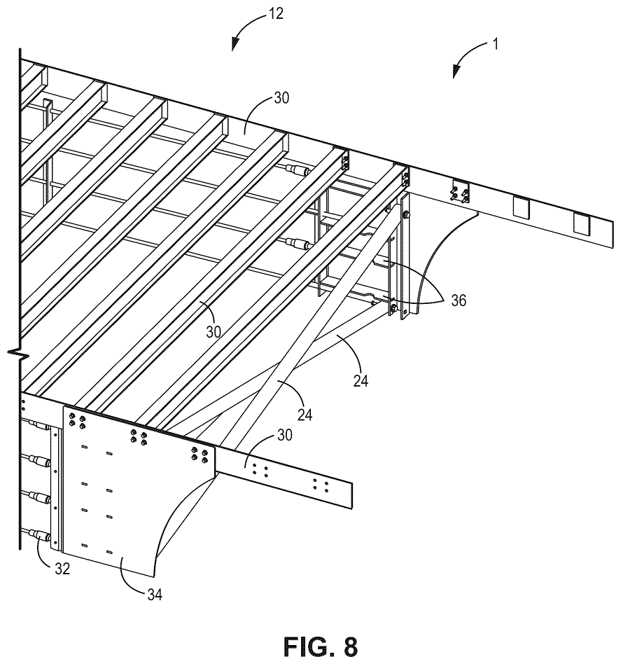

FIGS. 6, 7, and 8 show the rear mount 20 and surrounding components in detail, according to some implementations. In various implementations, the rear mount 20 includes a base plate 34 that is attached to the deck structure 30 of the trailer 10.

In various implementations, one or more anchor plates 36 are affixed to the base plate 34. In some implementations, the anchor plates 36 are oriented to be substantially parallel to the cables 22, which is optionally substantially parallel to the trailer deck 30, as would be understood.

In some implementations, a tensioning plate 38 is attached to the anchor plates 36 and/or base plate 34. In various implementations, the attachments between the base plate 34, anchor plates 36, and tensioning plate 38 may be welded joints. In other implementations, the attachments between the base plate 34, anchor plates 36, and tensioning plate 38 may be accomplished through bolting, brazing, soldering, adhesive bonding, riveting, or similar methods known to those in the art. In some implementations, the anchor plates 36 may be attached to the base plate 34 by using hooked tabs inserted into corresponding holes, which are held in place by tension in the cables 22, as will be discussed more below.

In some implementations, the cables 22, at the ends nearest the rear mount 20, may be attached to the tensioning plate 38 with termination devices 32. In certain implementations, the termination devices 32 joined to the tensioning plate 38 may have threaded ends 40 that are inserted through holes in the tensioning plate 38. These termination devices 32 may then also have nuts 42 that mate with the threaded ends 40 such that rotating the nuts 42 in one direction, typically clockwise, increases the tension on the cable 22, and rotating the nuts 42 in the other direction, typically counterclockwise, decreases the tension in the cable 22. In various implementations the tension in the cables 22 may be adjusted to sufficiently support the wind shield 28 and/or deflect objects in an impact scenario. As would be understood, the tension in the cables 22 may be adjusted periodically to compensate for stretch in the cables 22. In various implementations, the adjustment of tension is only done to ensure sufficient tension is applied to the cables 22. Various alternative methods and devices for tensioning are possible and would be appreciated by those of skill in the art.

Continuing with FIGS. 6, 7, and 8, the rear mount 20, in some implementations, may also have a brace mount 44. The brace mount 44 may be coupled to one end of one or more braces 24. In some implementations, the brace mount 44 may be coupled to a brace 24 via a through-bolt 46, though other methods are possible and would be understood.

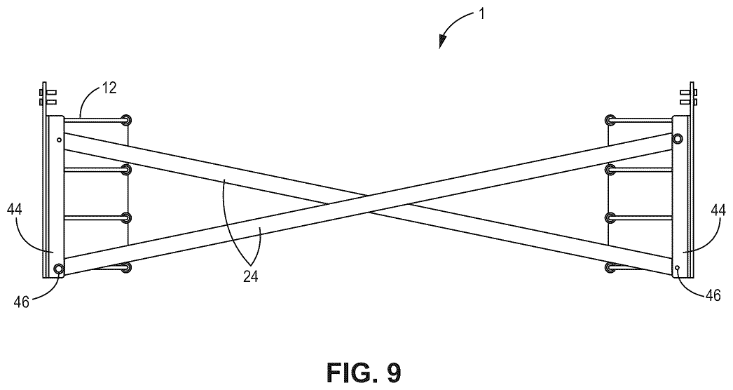

FIG. 9 shows one configuration of the braces 24 crossing to provide added stability to the rear mounts 20 and side underride guard 12.

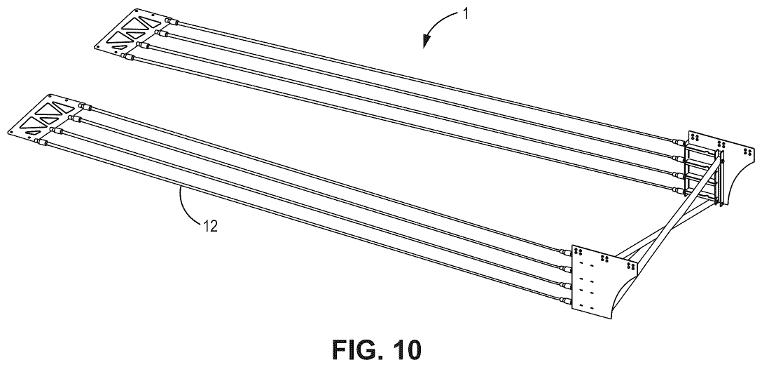

FIG. 10 shows one implementation of the system 1 and side underride guard 12 having no brackets 26 or wind shield 28. As would be understood, the side underride guard 12 as shown in FIG. 10 may allow for flexible ground clearance, as the cables 22 may flex when contacting the ground or objects on or near the ground, such as railroad tracks.

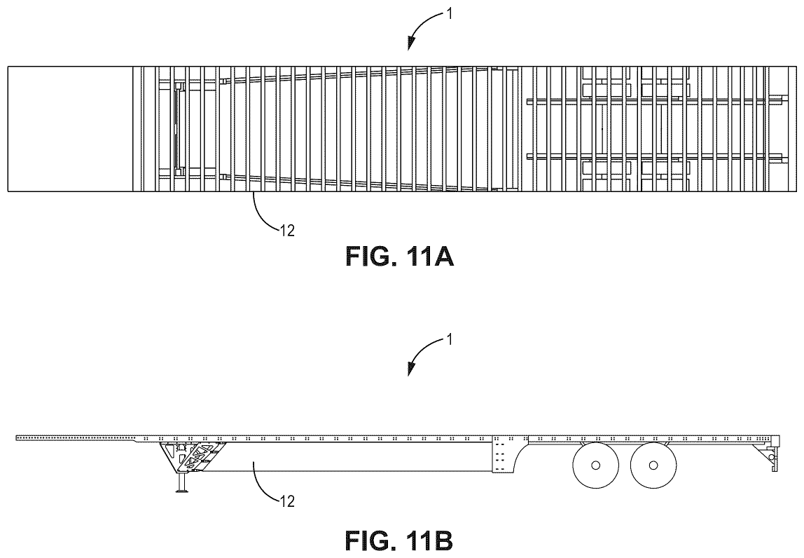

FIG. 11A shows a top-down view of the system 1 and side underride guard 12 applied on a trailer. As can be seen from this view, the underride guard 12 may be angled inward toward the front of the trailer, allowing for improved aerodynamics and an improved ability to deflect objects from under the trailer. FIG. 11B shows a side view of the system 1 and side underride guard 12 applied on a trailer.

As would be understood, the system 1 and side underride guard 12, described herein in its various implementations, may provide a more lightweight and efficient system compared to existing systems and devices. Specifically, regarding implementations using cables 22, it would be understood by those in the art that cables 22 are resilient when being impacted by vehicles and/or debris, as the cables 22 can flex to better avoid denting or breaking. Further, the cables 22 may be more easily replaced when damaged.

Although the disclosure has been described with reference to certain preferred embodiments, persons skilled in the art will recognize that changes may be made in form and detail without departing from the spirit and scope of the disclosed apparatus, systems and methods.

What is claimed is:

1. A side underride guard comprising:
(a) a front mount configured to attach to roadway equipment;
(b) a rear mount configured to attach to roadway equipment; and
(c) one or more cables attached to the front mount and the rear mount.

2. The side underride guard of claim 1, wherein the roadway equipment is a semi-trailer.

3. The side underride guard of claim 2, wherein the front mount attaches to the landing gear.

4. The side underride guard of claim 1, wherein the one or more cables comprise one or more termination devices.

5. The side underride guard of claim 4, wherein the one or more termination devices are configured to tension the one or more cables.

6. The side underride guard of claim 1, further comprising one or more brackets attached to the one or more cables.

7. The side underride guard of claim 6, further comprising a wind shield attached to the one or more brackets.

8. A side underride guard comprising:
(a) a first front mount disposed on a first side of a semi-trailer and a second front mount disposed on a second side of the semi-trailer;
(b) a first rear mount disposed on the first side of a semi-trailer and a second rear mount disposed on the second side of the semi-trailer;
(c) a first cable spanning between the first front mount and the first rear mount along the first side of the semi-trailer and a second cable spanning between the second front mount and the second rear mount along the second side of the semi-trailer; and
(d) one or more braces affixed to the first rear mount and second rear mount.

9. The side underride guard of claim 8, wherein there are two braces.

10. The side underride guard of claim 9, wherein the two braces span across a width of the semi-trailer between the first rear mount and the second rear mount.

11. The side underride guard of claim 9, wherein the two braces are crossed relative to one another.

12. The side underride guard of claim 8, further comprising one or more brackets along the first side of the semi-trailer and wherein the first cable is threaded through openings in the one or more brackets.

13. The side underride guard of claim 12, further comprising a wind shield attached to the one or more brackets.

14. The side underride guard of claim 8 wherein the one or more cables comprise one or more termination devices.

15. The side underride guard of claim 14, wherein the one or more termination devices are configured to tension the one or more cables.

16. A side underride guard comprising:
(a) a front mount configured to attach to a trailer;
(b) a rear mount configured to attach to the trailer;
(c) one or more cables attached to the front mount and the rear mount; and
(d) one or more brackets disposed along a first side of the trailer and support the one or more cables threaded through openings in the one or more brackets

17. The side underride guard of claim 16, further comprising one or more braces affixed to the rear mount.

18. The side underride guard of claim 16, further comprising at least one panel removably attached to the one or more brackets.

19. The side underride guard of claim 16, further comprising at least three cables.

20. The side underride guard of claim 16, wherein the one or more cables are braided steel cables.
